(19) United States
(12) Patent Application Publication
(10) Pub. No.: US 2026/0086225 A1
(43) Pub. Date: Mar. 26, 2026

(54) SEQUENCED SHORT-RANGE VEHICLE RADAR

(71) Applicant: Cypress Semiconductor Corporation, San Jose, CA (US)

(72) Inventors: Michael Thomas, San Jose, CA (US); Stephan Rasch, Unterföhring (DE)

(73) Assignee: Cypress Semiconductor Corporation, San Jose, CA (US)

(21) Appl. No.: 18/893,599

(22) Filed: Sep. 23, 2024

(51) Int. Cl. G01S 13/87; G01S 7/02; G01S 7/35; G01S 13/32; G01S 13/931

(52) U.S. Cl. CPC G01S 13/872; G01S 7/0235; G01S 7/354; G01S 13/32; G01S 13/931; G01S 2013/9314; G01S 2013/93275

(57) ABSTRACT

The embodiments described herein are directed at techniques for scheduling of activation of dual frequency radar transceivers. A device obtains, using the plurality of first radar transceivers, a first received radar signal. The device generates first radar data based on the first received radar signal to detect at least one radar target within a first detection region and a second detection region. The device obtains, using the second radar transceiver, a second received radar signal. The device generates second radar data based on the second received radar signal to detect the at least one radar target within a third detection region. In response to the generating the first radar data and the second radar data, the device simultaneously processes the first radar data and the second radar data to obtain radar targets information associated with the radar targets.

### TECHNICAL FIELD

The present disclosure relates generally to automotive radar systems, and more particularly, to systems and methods of sequenced sensing utilizing a combination of 60 Giga Hertz (GHz) and 77 GHz radar transceivers to improve distance measurement and simultaneous transceivers operation.

### BACKGROUND

Ultrasonic sensors have found widespread application in automotive systems, particularly for parking assistance. The ultrasonic sensors, while effective in certain applications, present significant limitations when used as automotive corner sensors. Ultrasonic sensors typically have a narrow beam that results in a limited field of view (FoV) (e.g., 30°). Another drawback is the ultrasonic sensors are susceptible to no-detection zones or blind spots. Due to the nature of ultrasonic wave propagation, the ultrasonic sensors struggle to detect an object located approximately 15-20 cm from the ultrasonic sensors within the limited FoV. This limitation can significantly compromise the ultrasonic sensors' ability to provide early warnings of potential hazards such as parked vehicles, pedestrians, cyclists, or walls in close proximity to the vehicle's corner.

Furthermore, the effectiveness of ultrasonic sensor requires a line of sight (LOS) so the ultrasonic sensors need to be placed on the bumper of the vehicles. The ultrasonics sensors positioned on the vehicle's bumper can impact the vehicle's aesthetics. Moreover, achieving a perfect color match between the ultrasonic sensors and the vehicle's paint is often challenging, resulting in an unsightly appearance. These cosmetic concerns can diminish the overall customer satisfaction with the vehicle.

### BRIEF DESCRIPTION OF THE DRAWINGS

The present embodiments are illustrated by way of example, and not of limitation, in the figures of the accompanying drawings.

FIG. 1A is a block diagram of an example of an automotive radar system utilizing automotive radar sensors of various frequencies, according to some embodiments of the present disclosure.

FIG. 1B is a block diagram illustrating a device, according to some embodiments of the present disclosure.

FIG. 2A illustrates an implementation scenario of embodiment an automotive radar system utilizing automotive radar sensors of various frequencies, according to some embodiments of the present disclosure.

FIG. 2B illustrates an implementation scenario of embodiment an automotive radar system utilizing automotive radar sensors of various frequencies, according to some embodiments of the present disclosure.

FIG. 3 illustrates an implementation scenario of embodiment an automotive radar system utilizing automotive radar sensors of various frequencies, according to some embodiments of the present disclosure.

FIG. 4 illustrates an implementation scenario of embodiment an automotive radar system utilizing automotive radar sensors of various frequencies, according to some embodiments of the present disclosure.

FIG. 5 illustrates a block diagram of embodiment of a microcontroller unit (MCU) system architecture, according to some embodiments of the present disclosure.

FIG. 6 illustrates a block diagram of an implementation of a combined 58-62 and 76-81 GHz automotive radar sensor circuit, according to some embodiments of the present disclosure.

FIG. 7 illustrates an example of an implementation scenario of embodiment 60 GHz radar sensor system, according to some embodiments of the present disclosure.

FIG. 8 illustrates an example of time-division multiplexing (TDM)-based radar scanning method using embodiment 60 GHz radar sensor system, according to some embodiments of the present disclosure.

FIG. 9 illustrates a block diagram of a computational system for the 60 GHz radar sensor, according to some embodiments of the present disclosure.

FIG. 10 illustrates an example of a system architecture for streaming raw radar data via controller area network flexible data-rate (CAN-FD) central computation, according to some embodiments of the present disclosure.

FIG. 11 illustrates an example of a system architecture for streaming raw radar data via CAN-FD central computation, according to some embodiments of the present disclosure.

FIG. 12 illustrates a block diagram of a parking control module receiving raw radar data via CAN-FD, according to some embodiments of the present disclosure.

FIG. 13 illustrates a block diagram of a computational system for the 60 GHz radar sensor, according to some embodiments of the present disclosure.

FIG. 14 illustrates an example of a parking control module receiving raw radar data via SERDES, according to some embodiments of the present disclosure.

FIG. 15 illustrates a block diagram of a computational system for the 60 GHz radar sensor as edge compute node sensor sending radar target data to the Parking Control Module via CAN-FD, according to some embodiments of the present disclosure.

FIG. 16 is a block diagram illustrating an example data processing method for an object sensing using 60 GHz and 77 GHz radar sensors, according to some embodiments of the present disclosure.

FIG. 17 is a block diagram illustrating an example data processing method for an object sensing using 60 GHz radar sensors, according to some embodiments of the present disclosure.

FIG. 18 is a block diagram of a device, according to some embodiments of the present disclosure.

FIG. 19 is a block diagram of a device deployed in an automobile configured to receive radar signals, according to some embodiments of the present disclosure.

### DETAILED DESCRIPTION

In the following description, for purposes of explanation, numerous specific details are set forth in order to provide a thorough understanding of the present embodiments. It will be evident, however, to one skilled in the art that the present embodiments may be practiced without these specific details. In other instances, well-known circuits, structures, and techniques are not shown in detail, but rather in a block diagram in order to avoid unnecessarily obscuring an understanding of this description.

Reference in the description to “one embodiment” or “an embodiment” means that a particular feature, structure, or characteristic described in connection with the embodiment is included in at least one embodiment. The phrase “in one embodiment” located in various places in this description does not necessarily refer to the same embodiment.

Short-range sensing is primarily employed for parking assistance and low-speed maneuvers. Short-range sensing typically employs an ultrasonic sensing system consisting of six ultrasonic sensors as front sensors and six ultrasonic sensors as rear sensors. These ultrasonic sensors are often integrated into the vehicle's bumpers or grille to provide accurate measurements of proximity to nearby objects. These ultrasonic sensors of the employed ultrasonic sensing system receive ultrasonic signals to generate data for processing. The generated data is formatted and transmitted to a parking control module via a daisy-chain connection. The parking control module includes a microcontroller unit (MCU) that processes the data to obtain distance information within the field of view (FoV) of the ultrasonic sensors.

Aspects of the present disclosure address the above-noted and other deficiencies by replacing the ultrasonic sensors with multiple radar transceivers operating in different frequency bands and routing the digitized intermediate frequency (IF) radar signal to a single MCU to process the radar signals simultaneously. The embodiments described herein are directed at techniques to utilize time-division multiplexing (TDM) to minimize interference of radar transceivers operating in the same frequency band.

In some examples, embodiments of the present disclosure use an automotive radar sensor module including an integrated MCU for dedicated radar signal processing. The automotive radar sensor module includes a 60 (Giga Hertz) GHz radar sensor and the 77 GHz radar sensor with TDM-based radar sequencing to acquire the received radar signals. The received radar signals are processed using dedicated radar signal processing units (SPUs) included in the single MCU. The signal processing for the received 60 GHz and 77 GHz radar signals can be processed simultaneously using the single MCU. Integrating a single MCU into the automotive radar sensor module has the potential to reduce the costs and simplify the system architecture. By having a separate transceiver for the 60 GHz radar sensor and 77 GHz radar sensor, both signals can be transmitted simultaneously from the 60 GHz radar transceiver and 77 GHz radar transceiver without causing destructive interference to either.

The automotive radar sensor module with an integrated MCU for dedicated radar signal processing can improve the reliability of radar functions in bad weather conditions. Increased radio frequency (RF) performance is a prerequisite for the successful deployment of dependable assisted and automated driving functions for all SAE levels up to Level 4.

In some embodiments, the automotive radar sensor module can include radar transceivers to transmit and receive radar signals. The automotive radar sensor module includes an MCU to perform radar processing on the received radar signal to generate radar data. The radar data is distributed to modules within the vehicle using data buses and protocols such as controller area network flexible data-rate (CAN-FD) or Ethernet®.

In one embodiment, an apparatus is disclosed, the apparatus includes a device to iteratively perform the following steps until each of 60 GHz radar sensors have been activated. The device may perform 60 GHz radar sensing operations. The device may activate a first group of 60 GHz radar sensors to transmit and receive 60 GHz radar signals to detect the radar targets within a first group of 60 GHz detection regions. Then, the device may activate a second group of 60 GHz radar sensors to transmit and receive 60 GHz radar signals to detect the radar targets within a second group of 60 GHz detection regions. The activation of the first and second groups of the 60 GHz radar sensors may be repeated. The device may simultaneously process the 60 GHz radar data associated with the first and second groups of the 60 GHz radar sensors. The terms “sensors and transceivers are used interchangeably herein.

In one embodiment, the device may perform 60 GHz and 77 GHz radar sensing operations simultaneously. As described above, the device may activate a first group of 60 GHz radar sensors to transmit and receive 60 GHz radar signals to detect the radar targets within a first group of 60 GHz detection regions. Then, the device may activate a second group of 60 GHz radar sensors to transmit and receive 60 GHz radar signals to detect the radar targets within a second group of 60 GHz detection regions. While the first and second groups of the 60 GHz radar sensors are activated, the device activates the 77 GHz radar sensors to transmit and receive 77 GHz radar signals to detect the radar targets within 77 GHz detection regions. The device may repeat the 60 GHz and 77 GHz radar sensing operations. The device may simultaneously process the 60 GHz associated with the 60 GHz radar sensors and 77 GHz radar data associated with the 77 GHz radar sensors.

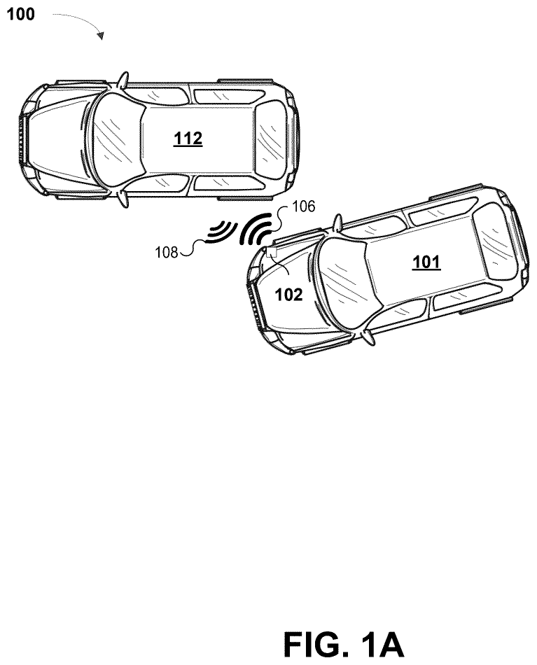

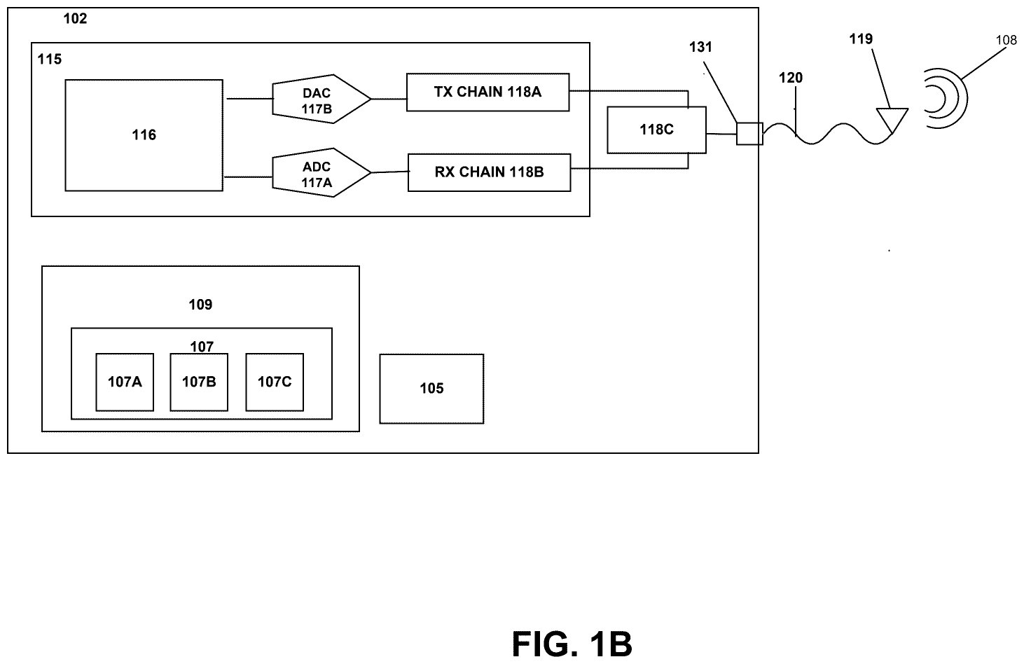

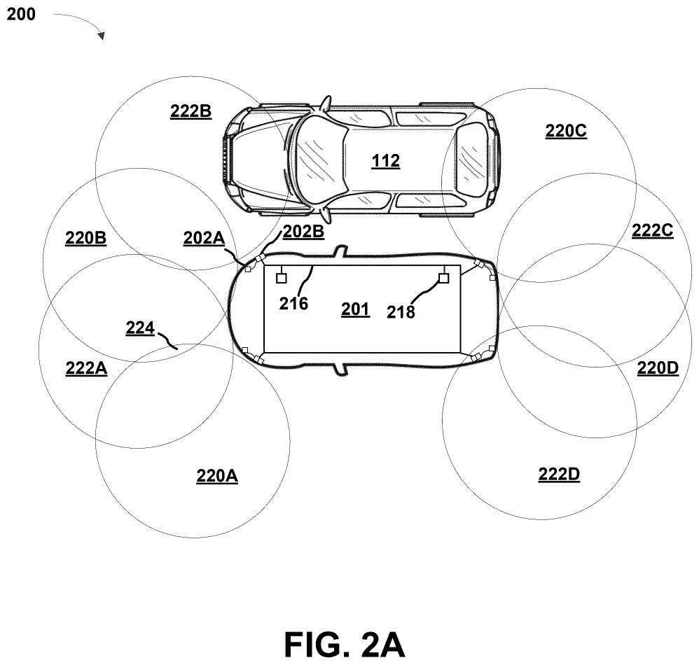

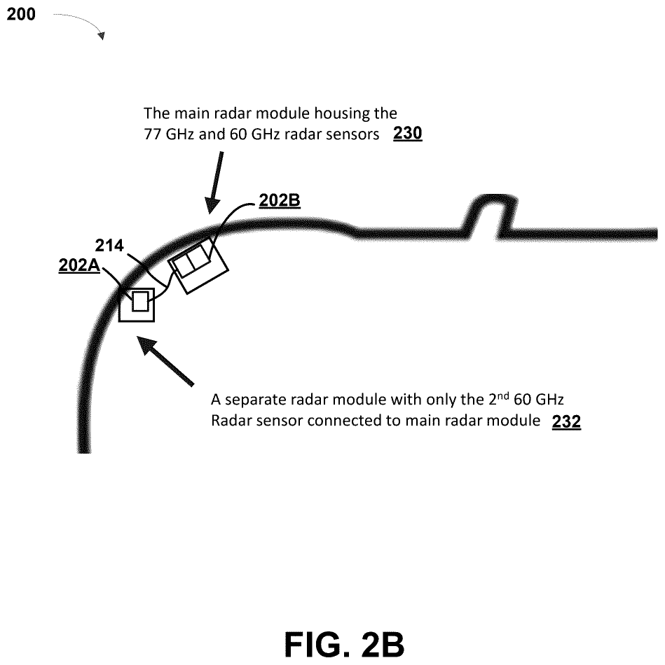

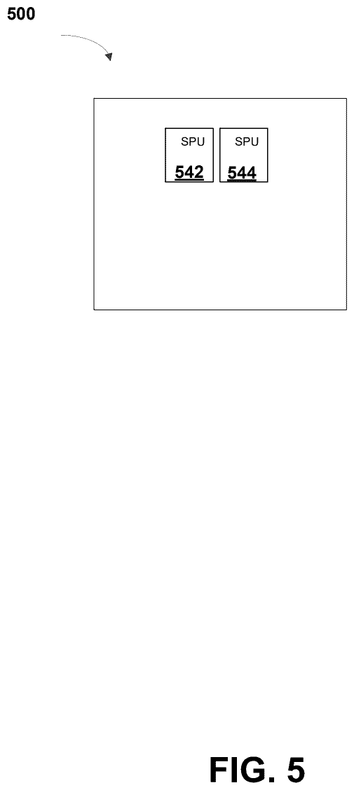

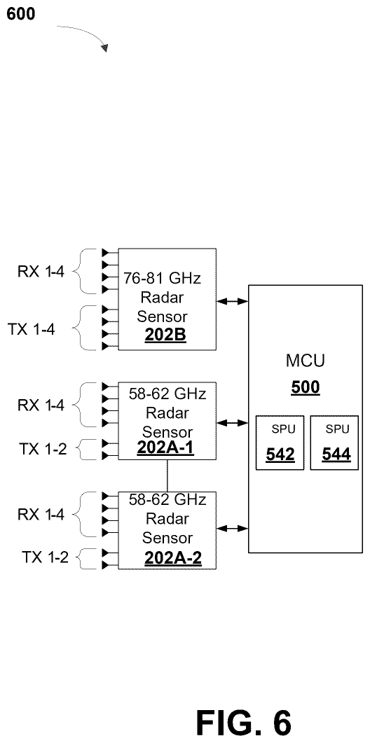

FIG. 1A is an example of a scenario 100 in which devices including automotive radar sensors of various frequencies are utilized by vehicles during a parallel parking procedure, according to some embodiments of the present disclosure. As illustrated in FIG. 1A, scenario 100 depicts a vehicle 101 that is in motion and an object 112 (e.g., a parked vehicle). The vehicle 101 may include a device 102. The vehicle 101, assisted by the device 102, for example, is navigating a tight parking space without hitting the object 112 (the parked vehicle) during a parallel parking procedure. As will be discussed below in reference to FIG. 6, the device 102 includes an automotive radar transceiver. The device 102 also includes an MCU (shown as MCU 500 in FIG. 5) that controls the operation of the device 102. As will be described in connection with FIG. 6, the MCU performs various radar signal processing operations on the data generated by the device 102. As will be discussed below in FIG. 2A, the device 102 may be integrated into or mounted behind a surface of a vehicle's bumper.

During operation, device 102 transmits RF signals 106 into the environment via an antenna. The environment may be a sensing area in which the object 112 is located. The environment may be any area within the field-of-view of the d device 102 and adjacent to the bumper of the vehicle 101.

The transmitted RF signals 106 may be reflected by object 112 (e.g., the parked vehicle) that is present within the environment in a direction of the RF signals 106. The object 112 may be stationary or moving. Although the object 112 is illustrated as the parked vehicle, the object 112 may also include (for example) a person, an animal, a building, some furniture, a plant, or a wall.

The received RF signals 108 may be attenuated due to various phenomena (e.g., propagation, diffraction, scattering, multipath fading, or the like). The object 112 may alter the characteristics (e.g., amplitude, phase shift) of the signal 108. The object 112 can also affect the signal 108 to reflect, diffract, or scatter, which causes the signal to propagate across multiple propagation paths.

The received RF signals 108 reflected by the object 112 may be received by the device 102. The device 102 may down convert the received RF signals to generate a baseband signal. The baseband signal may be processed (filtered, decoded, digitized, etc.) by a receive chain (shown as receive chain 118B in FIG. 1B) in the device 102. For example, an analog-to-digital converter (ADC) included in the MCU of the device 102 down converts the received RF signals 108 converting them to a digital signal. The MCU processes the digital signal of the received RF signals 108 for determining the presence of the object 112 (e.g., vehicle) within the area. The result of this processing generates various data that may be indicative of the presence of the object 112 within the area, and such data may be used by parking control module to help a driver safely navigate tight parking spaces, or other surrounding environmental features around vehicle 101.

In some embodiments, the device 102 may operate as a frequency-modulated continuous-wave (FMCW) radar sensor having multiple transmit and receive channels. However, other types of radar circuits may be used such as a continuous wave radar circuit, a fixed beam radar circuit, a pulse radar circuit, a Monte Carlo forecasting of waves (MCFW) radar circuit, and non-linear frequency modulation (NLFM) radar circuit to implement device 102.

In some embodiments, the presence, location, and/or motion of object 112 within the environment may be determined by taking a fast Fourier transform (FFT) of the baseband radar signal generated by the FMCW radar sensor. The motion of the object may be determined, for example, by taking further FFTs to determine object's velocity using Doppler analysis techniques. In embodiments in which the device 102 includes a receive antenna array, further FFTs may also be used to determine the azimuth of the object 112 with respect to the device 102.

FIG. 1B is a block diagram illustrating a device 102, which may be a communication circuit that includes a transceiver operating using a communication protocol. The device 102 may represent device 102 as described in FIG. 1A. In the example of FIG. 1B, the device 102 may include a radar transceiver 115. In addition, the device 102 may be implemented on a single die, or may be implemented using multiple dies in a single package or multiple packages. The device 102 may also be implemented on a module. The radar transceiver 115 may comprise a transmit chain 118A and a receive chain 118B and both the transmit chain 118A and the receive chain 118B may be comprised of signal processing components such as a low-noise amplifier (LNA), a mixer, a variable gain amplifier (VGA), and a low pass filter (LPF; not illustrated). The radar transceiver 115 may further comprise a Transmitter/Receiver (Tx/Rx) switch 118C to switch between the Tx chain 118A and the Rx chain 118B. More specifically, the Tx/Rx switch 118C may selectively couple the port 131 to the Tx chain 118A to allow for transmission of signals via an antenna 119 or couple the port 131 to the Rx chain 118B to allow for reception of signals via the antenna 119. A transmission line 120 may be coupled to the port 131 and to the antenna 119. The transmission line 120 may be any appropriate type of medium such as a wire, a cable, a waveguide, or a microstrip transmission line. The Rx chain 118B may also be coupled to an analog-to-digital converter (ADC) 117A which it may use to digitize received signals and output the digitized signals to a digital demodulator 116 (also referred to as a digital detector) which may extract any information content from the received digitized signals (e.g., by extracting the information bearing signal from a carrier wave). A digital-to-analog converter (DAC) 117B may be used to convert the digitized signals and output the analog signals for the Tx chain 118A.

As shown in FIG. 1B, device 102 further includes a processing device 105 and a memory 109. The memory 109 may include radar sensing module 107 comprising instructions which may be executed by the processing device 105 to perform the TDM-based radar sensing techniques described herein. Although illustrated, by way of example, as a software module stored in memory 109 and accessed/executed by processing device 105, the functionality of the radar sensing module 107 may also be realized using dedicated hardware (e.g., an application specific integrated circuit (ASIC)). The radar sensing module 107 may include a radar activation module 107A, a signal processing module 107B and a machine learning module 107C. The functions of the radar sensing module 107 (i.e., the methods depicted in FIGS. 2A-17) may be distributed among the radar activation module 107A, the signal processing module 107B and the machine learning module 107C as described in further detail herein.

In some embodiments, the activation module 107A may be used by the radar sensor system 200 of FIG. 2A to control the activation of the radar sensor according to a TDM technique. The activation module 107A may control which radar sensor is activated at a predefined time slot. The activation module 107A may also control the sequence of the activation of multiple radar sensors. In some embodiments, the signal processing module 107B may be used by the radar sensor system 200 to simultaneously process the 60 GHz radar data and the 77 GHz radar data as will be described in detail below. The machine learning module 107C may be used to perform neural network processing in connection with radar processing for object detection described herein.

FIG. 2A illustrates an implementation scenario of embodiment an automotive radar system 200 utilizing automotive radar sensors of various frequencies, according to some embodiments of the present disclosure. Referring to FIG. 2A, the automotive radar system 200 of a vehicle 201 includes 60 GHz radar sensor 202A, 77 GHz radar sensor 202B, MCU (not shown), vehicle ethernet bus 216, and zone control module 218. Note that radar frequencies other than 60 GHz and 77 GHZ may also be used. The MCU may be included within the 60 GHz radar sensor 202A and the 77 GHz radar sensor 202B. In some embodiments, for aesthetics purposes, the 60 GHz radar sensor can be positioned behind the vehicle bumper. This overcomes the issue of achieving a perfect color match between the sensors and the vehicle's paint, resulting better customer satisfaction with the vehicle aesthetics. Note that other locations on the bumper of the vehicle may be possible for the radar sensor in other embodiments.

The 60 GHz radar sensor 202A receives 60 GHz radar signal and the 77 GHz radar sensor 202B receives 77 GHz radar signal. The 60 GHz radar sensor 202A may be used for an ultra-short range application while the 77 GHz radar sensor 202B may be used for a long-range 4D application. In some embodiments, the 60 GHz radar sensor 202A can be combined with the 77 GHz radar sensor 202B as a corner radar sensor module. Unlike ultrasonic sensors, radar sensors have a longer range and wider FoV. For example, radar sensors may be capable of up to 10 meters of range and 120° FoV.

As described above, the MCU processes the digital signal of the received RF signals for determining the presence of the object within the sensing area. Vehicle ethernet bus 216 is an Ethernet-based communication network that allows data to be transmitted between different electronic modules in a vehicle. Vehicle ethernet bus 216 can provide a support for high-volume data transfer between in-vehicle electronic modules. In some embodiments, the vehicle ethernet bus 216 may be 1000Base-T1 Ethernet. In some embodiments, the vehicle ethernet bus 216 transmits data from the 60 GHz radar sensor to the in-vehicle electronic module such as zone control module 218. Zone control module 218 controls the operation of the 60 GHz radar sensor and 77 GHz radar sensor. Note that other data buses and communication protocols may be used, such as CAN.

Still referring to FIGS. 2A, 60 GHz radar transceivers can generate eight beams 220A, 222A, 220B, 222B, 220C, 222C, 220D, 222D. Beams 220A and 220B can form an odd beam pair. Similarly, beams 220C and 220D can form an odd beam pair. Beams 222A and 222B can form an even beam pair. Similarly, beams 222C and 222D can form an even beam pair.

The four 60 GHz radar sensors at the front and the four 60 GHz radar sensors at the rear of the vehicle 101 can provide multiple coverages for the front and rear of the vehicle 101. The overlapping beams of the 60 GHz radar sensors provide a redundant coverage. For example, the overlapping of the beam 220A and the beam 220B provides a redundant coverage 224.

In some embodiments, an overlapping of beams from two of the plurality of the first radar transceivers is below a predefined threshold to minimize signal interference. For example, an overlapping of beam 220A and 220B is below a predefined threshold to minimize signal interference.

FIG. 2B illustrates an implementation scenario of embodiment an automotive radar system 200 utilizing automotive radar sensors of various frequencies, according to some embodiments of the present disclosure. Referring to FIG. 2B, as shown, the 60 GHz radar sensor 202A and the 77 GHz radar sensor 202B can be positioned at the right front corner position of the vehicle 201. The automotive radar system can be installed in all four corners of the vehicle 201.

As shown, the automotive radar system positioned at a right front corner of the vehicle can include a main radar module 230 and a satellite radar module 232. The main radar module 230 can include a combination of the 60 GHz radar sensor and the 77 GHz radar sensor. The satellite radar module 232 can include a 60 GHz radar sensor. The main radar module 230 can be connected and in communication with the main radar module 232 via a wire harness 214. The main radar module 230 may provide power to the satellite radar module 232 via the wire harness 214.

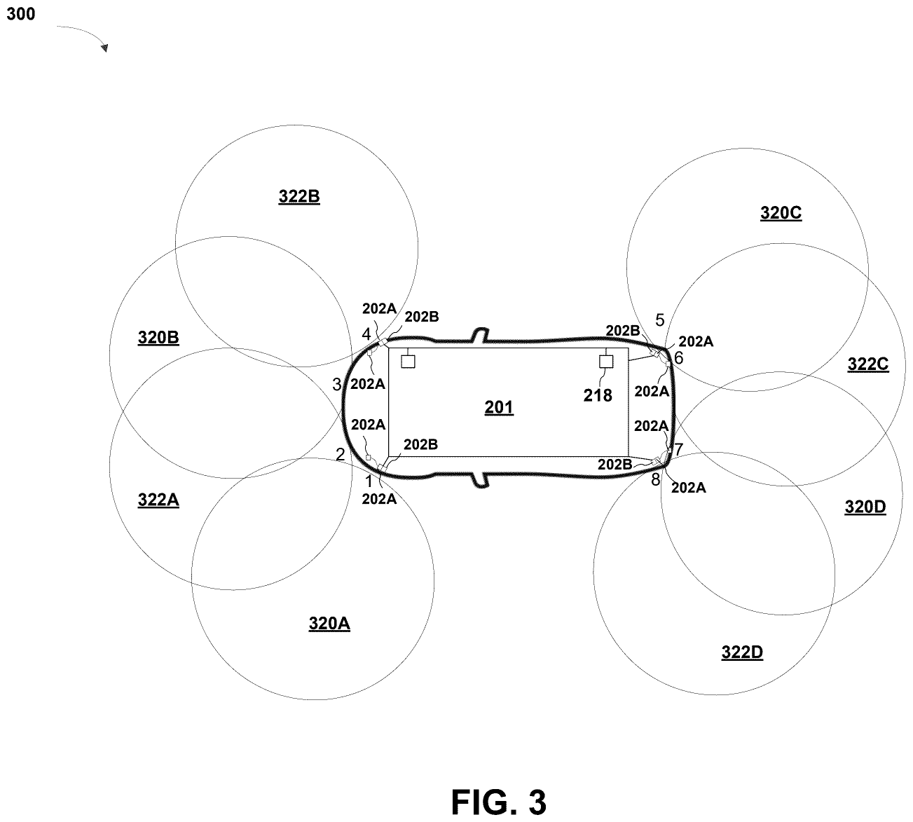

FIG. 3 illustrates an implementation scenario of embodiment an automotive radar system 300 utilizing automotive radar sensors of various frequencies, according to some embodiments of the present disclosure. The automotive radar system 300 may be the automotive radar system 200 as described in FIG. 2A.

In some embodiments, the 60 GHz radar sensors operation may be based on the TDM technique to minimize interference from adjacent 60 GHz radar sensors. TDM technique allows multiple transmitted and received radar signals to share a single communication channel. The TDM technique divides the single communication channel into time slots so that each transmitted and received radar signal can use the single communication channel. The TDM technique allocates time slot for an activation of radar sensor or groups or radar sensors representing less than all radar sensors in the system. During this activation, the transmitter of the radar sensor transmits the radar signal. For example, referring to FIG. 3, zone control module 218 allocates a first time slot for the activation of a first group of the 60 GHz radar sensors. The zone control module 218 initially activates odd numbered 60 GHz radar sensors 202A to transmit 60 GHz radar signals corresponding to beams 220A, 220B, 220C, and 220D as shown in FIG. 2A. The transmission of the 60 GHz radar signal generates multiple beams (e.g., 320A, 320B, 320C, and 320D) to cover a first sensing region. Beam 320A may cover a region surrounding a front left corner of the vehicle 201 while beam 320B may cover a region surrounding left side of a front of the vehicle 201. Beam 320C may cover a region surrounding a rear right corner of the vehicle 201 while beam 320D may cover a region surrounding left side of a rear of the vehicle 201. Still referring to FIG. 3, zone control module 218 allocates a second time slot for the activation of a second group of the 60 GHz radar sensor. The zone control module 218 activates even numbered 60 GHz radar sensors 202A to transmit 60 GHz radar signals corresponding to beams 222A, 222B, 222C, and 222D of FIG. 2A. The transmission of the 60 GHz radar signal generates multiple beams to cover a second sensing region. (e.g., 322A, 322B, 322C, and 322D). Beam 322B may cover a region surrounding a front right corner of the vehicle 201 while beam 322A may cover a region surrounding left side of a front of the vehicle 201. Beam 322D may cover a region surrounding a rear left corner of the vehicle 201 while beam 322C may cover a region surrounding right side of a rear of the vehicle 201. While embodiments above describe the activation of 60 GHz radar sensors, zone control module 218 may perform a similar method with 77 GHz radar sensors.

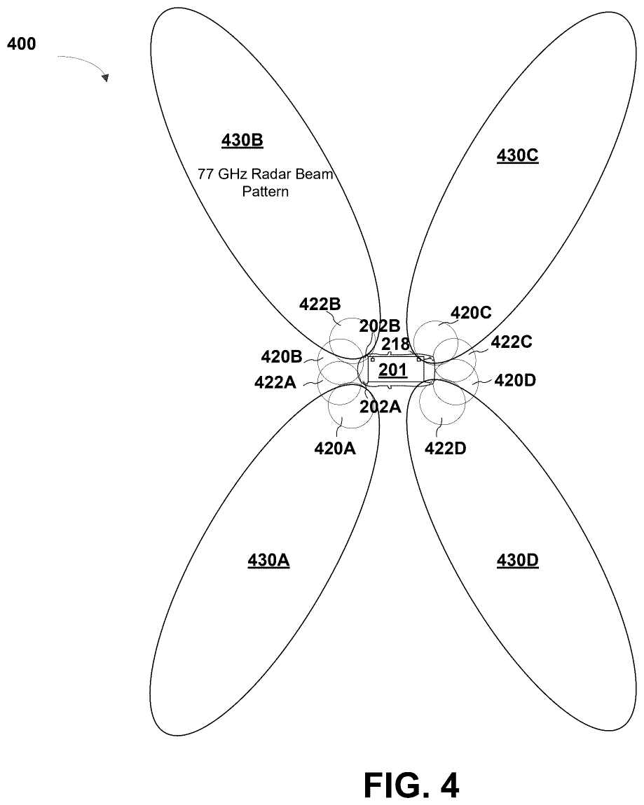

FIG. 4 illustrates an implementation scenario of embodiment an automotive radar system 400 utilizing automotive radar sensors of various frequencies, according to some embodiments of the present disclosure. Referring to FIG. 4, the automotive radar system 400 includes multiple 60 GHz radar sensors and multiple 77 GHz radar sensors as described above.

In some embodiments, a transmitter of 60 GHz radar transceivers 202A transmits a 60 GHz radar signal. A receiver of 60 GHz radar transceivers 202A receives a 77 GHz radar signal. The 60 GHz radar signal received by the receiver of the 60 GHz radar transceivers 202A is a reflected version of the RF signal transmitted by the transmitter of the 60 GHz radar transceivers 202A. The 60 GHz radar transceivers 202A generate 60 GHz radar data based on the 60 GHz radar signal received by the receiver of the 60 GHz radar transceivers 202A to detect the radar targets within a first detection region (e.g., corresponding to beams 420A, 420B, 420C, 420D) and a second detection region (e.g., corresponding to beams 422A, 422B, 422C, 422D).

Together with the 60 GHz radar transceivers 202A, 77 GHz radar transceivers 202B iteratively obtain a 77 GHz radar signal. A transmitter of the 77 GHz radar transceiver 202B transmits the 77 GHz radar signal. A receiver of the 77 GHz radar transceiver 202B receives the 77 GHz radar signal. The 77 GHz radar signal received by the receiver of the 77 GHz radar transceivers 202B is a reflected version of the RF signal transmitted by the transmitter of the 77 GHz radar transceivers. The 77 GHz radar transceivers 202B generate 77 GHz radar data based on the 77 GHz radar signal received by the receiver of the 77 GHz radar transceivers 202B to detect the radar targets within a 77 GHz detection region. The 77 GHz region is an area that is covered by the beam 430A, 430B, 430C, and 430D.

In response to the generating the first radar data and the second radar data, two SPUs (e.g., 542, 544 as shown in FIG. 5) within the MCU 500 simultaneously process the 66 GHz radar data and the 77 GHz radar data to obtain radar target information associated with the radar targets. As will be described in connection with FIG. 5 below, a first SPU 542 processes (e.g., filters, decodes, digitizes) the 60 GHz radar data and a second SPU 544 processes the 77 GHz radar data. The first SPU 542 and the second SPU 544 perform simultaneous signal processing of the 60 GHz radar data and the 77 GHz radar data.

In some embodiments, both the 60 GHz radar sensors and the 77 GHz radar sensors can be activated simultaneously. The 60 GHz radar transceivers generate eight beams 420A, 422A, 420B, 422B, 420C, 422C, 420D, 422D. Simultaneously, the 77 GHz radar transceivers generate four beams 430A, 430B, 430C, and 430D.

In some embodiments, as indicated by the four beams 430A, 430B, 430C, and 430D, the 77 GHz radar sensor has a greater detection range compared to the 60 GHz radar sensor. The greater detection range can enable a reliable object separation and detection necessary for protecting vulnerable road users including motorcyclists, cyclists, or pedestrians.

FIG. 5 illustrates a block diagram of embodiment of an MCU 500 system architecture, according to some embodiments of the present disclosure. Referring to FIG. 5, the MCU 500 represent AURIX™ TC35xTA microcontroller in embedded Flash 40 nm Technology.

The received RF signals by the 60 GHz radar sensor 202A and the 77 GHz radar sensor 202B can be processed separately by dedicated SPUs. A first SPU 542 processes the received RF signals received by the 60 GHz radar sensor 202A and a second SPU 544 processes the received RF signals received by the 77 GHz radar sensor 202B. As described above, the MCU 500 is equipped with two SPUs (e.g., 542, 544) enabling a simultaneous radar signal processing of two separate radar signal paths. Thus, the radar data from both the 60 GHz radar sensor 202A and the 77 GHz radar sensor 202B and can be processed simultaneously by their dedicated SPU (e.g., 542, 544). In this manner, data acquired by multiple radar sensors within a single radar module can be processed using a single MCU 500. In some embodiments, radar data obtained by different groups of radar sensors can be processed simultaneously. As an example, with reference to FIGS. 4, 60 GHz radar data obtained by a group of 60 GHz radar sensors 202A located at the front of the vehicle 201 (corresponding to beams 420A, 422A, 420B, 422B) can be processed by SPU 542 and the 60 GHz radar data obtained by a group of 60 GHz radar sensor 202A located at the rear of the vehicle 201 (corresponding to beams 420C, 422C, 420D, 422D) can be processed by SPU 544. In another example, radar data obtained by a group of 60 GHz radar sensors 202A and a group of 77 GHz radar sensors 202B located at the front of the vehicle 201 (corresponding to beams 420A, 422A, 420B, 422B, 430A, 430B) can be processed by SPU 542 and radar data obtained by a group of 60 GHz radar sensors 202A and a group of 77 GHz radar sensors 202B located at the back of the vehicle 201 (corresponding to beams 420C, 422C, 420D, 422D, 430C, 430D) can be processed by SPU 542. In some embodiments, radar data associated with non-overlapping detection region of the 60 GHz radar sensors 202A and 77 GHz radar sensors 202B can be processed simultaneously. For example, 60 GHz radar data associated with a 60 GHz detection region (corresponding to beam 422A) and the 77 GHz radar data associated with a 77 GHz detection region (corresponding to beam 430B) can be processed by SPU 542 and 60 GHz radar data associated with a 60 GHz detection region (corresponding to beam 420B) and the 77 GHz radar data associated with a 77 GHz detection region (corresponding to beam 430A) can be processed by SPU 544.

FIG. 6 illustrates a block diagram of an implementation of a combined 58-62 and 76-81 GHz automotive radar sensor system 600, according to some embodiments of the present disclosure. Referring to FIG. 6, an MCU 500 is in communication with three radar sensors 202A-1, 202A-2, and 202B. 58-62 GHz radar sensors 202A-1 and 202A-2 can transmit 60 GHz radar signals via one of the two transmitter channels (TX 1-2) and receive the received 60 GHz radar signals from the object on the four receiving channels (RX 1-4). Similarly, 76-81 GHz radar sensor 202B can transmit 77 GHz radar signals via one of the four transmitter channels (TX 1-4) and receive the received 77 GHz radar signals from the object on the four receiving channels (RX 1-4). The MCU 500 can process radar signals obtained from the three separate radar sensors 202A-1, 202A-2, and 202B. The MCU 500 may include SPU 542 dedicated for processing 60 GHz radar signals obtained by the 58-62 GHz radar sensors 202A-1, 202A-2 and SPU 544 dedicated for processing 77 GHz radar signals obtained by the 76-81 GHz radar sensor 202B. Radar sensors 202A-1 and 202A-2 may form a compact 60 GHz radar sensor 202A and equipped with an antenna in package (AiP).

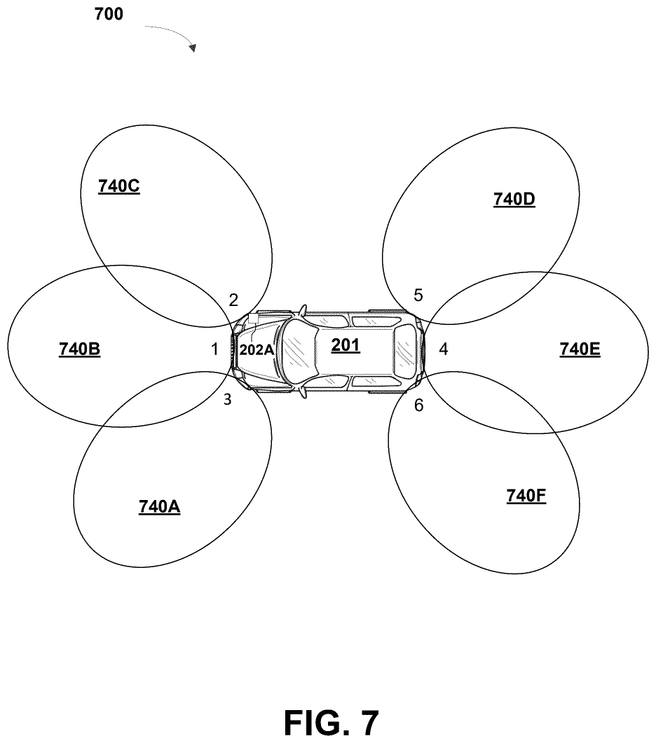

FIG. 7 illustrates an example of an implementation scenario of embodiment 60 GHz radar sensor system 700, according to some embodiments of the present disclosure. Referring to FIGS. 7, 60 GHz radar sensor system 700 can include multiple 60 GHz radar sensors 202A positioned at various locations of the vehicle 201, though only a single 60 GHz radar sensor 202A is illustrated for clarity of presentation. For example, six 60 GHz radar sensors 202A are positioned at a front, rear, and four corner of a vehicle 201. The six 60 GHz radar sensors 202A can generate multiple beams. For example, front 60 GHz radar sensor 202A generates beam 740B. Rear 60 GHz radar sensor 202A generates beam 740E. Corner 60 GHz radar sensors 202A generate beams 740A, 740C, 740D, and 740F. In some embodiments, the 60 GHz radar sensors 202A can be integrated into or mounted behind a surface of a bumper of the vehicle 201.

Due to the wide FoV (e.g., 120°) a single 60 GHz radar sensor 202A can replace two ultrasonic sensors to generate the same beam. For example, six 60 GHz radar sensors 202A can replace twelve ultrasonic sensors integrated at the front, rear, and corner of the vehicle 201. The 60 GHz radar sensor 202A can generate a high-density data set including a 3D point cloud. The 60 GHz radar sensor system 700 can use the 3D point cloud to detect multiple targets (static or moving) and determine the velocity and direction of the moving targets.

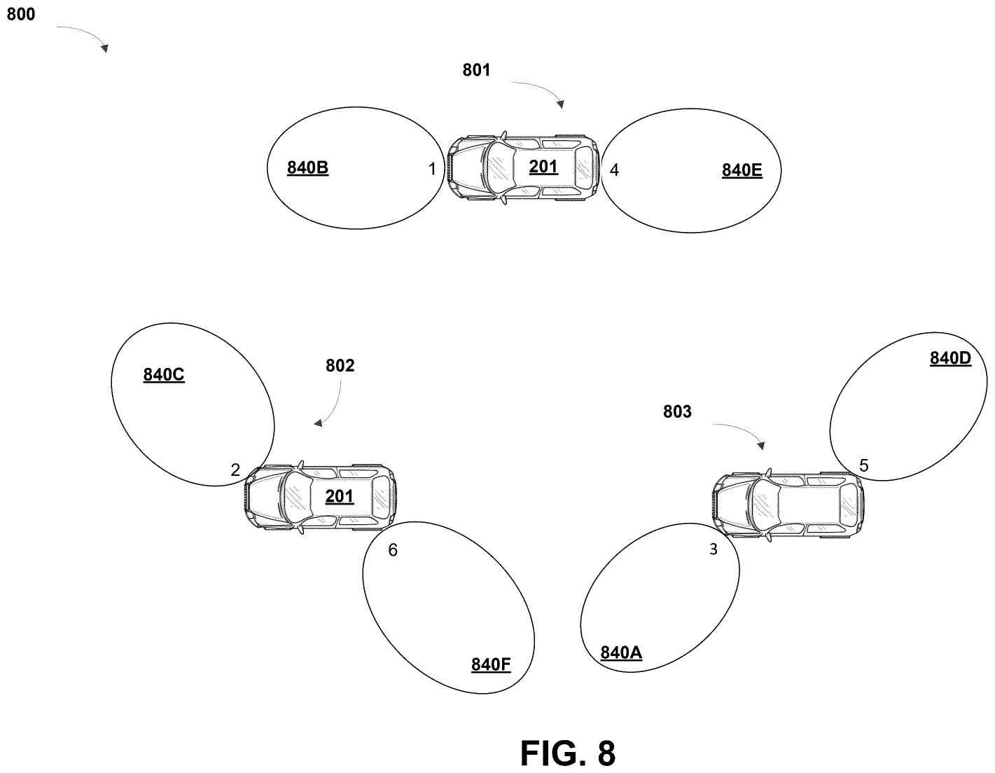

FIG. 8 illustrates an example of TDM-based radar scanning method 800 using embodiment 60 GHz radar sensor system, according to some embodiments of the present disclosure. In some embodiments, at step 1 801, TDM-based radar scanning method begins by activating the front 60 GHz radar sensor to generate a beam 840B and the rear 60 GHz radar sensor to generate a beam 840E. This would then sense the area directly in front and to the rear of the vehicle 201 simultaneously. The MCU 500 as described in FIG. 5 would then perform the radar signal processing for both radar channels via the two SPUs 542, 544 in the device.

In some embodiments, at step 2 802, after activating the front 60 GHz radar sensor to generate the beam 840B and the rear 60 GHz radar sensor to generate the beam 840E, TDM-based radar scanning method 800 activates the right front corner 60 GHz radar sensor to generate a beam 840C and the rear left corner 60 GHz radar sensor to generate a beam 840F. This time the sense area shifts to the opposing corners of the vehicle 201, reducing any interference from simultaneous signals.

In some embodiments, at step 3 803, TDM-based radar scanning method 800 continues by activating the left front corner 60 GHz radar sensor to generate a beam 840A and rear right corner 60 GHz radar sensor to generate a beam 840D. Now the sensing area is swapped to the other two opposing corners of the vehicle 201. The three steps 801, 802, 803 complete a sequence of TDM-based radar scanning method 800. TDM-based radar scanning method 800 can then be repeated based on a round robin approach after the completion of the three steps 801, 802, 803 above.

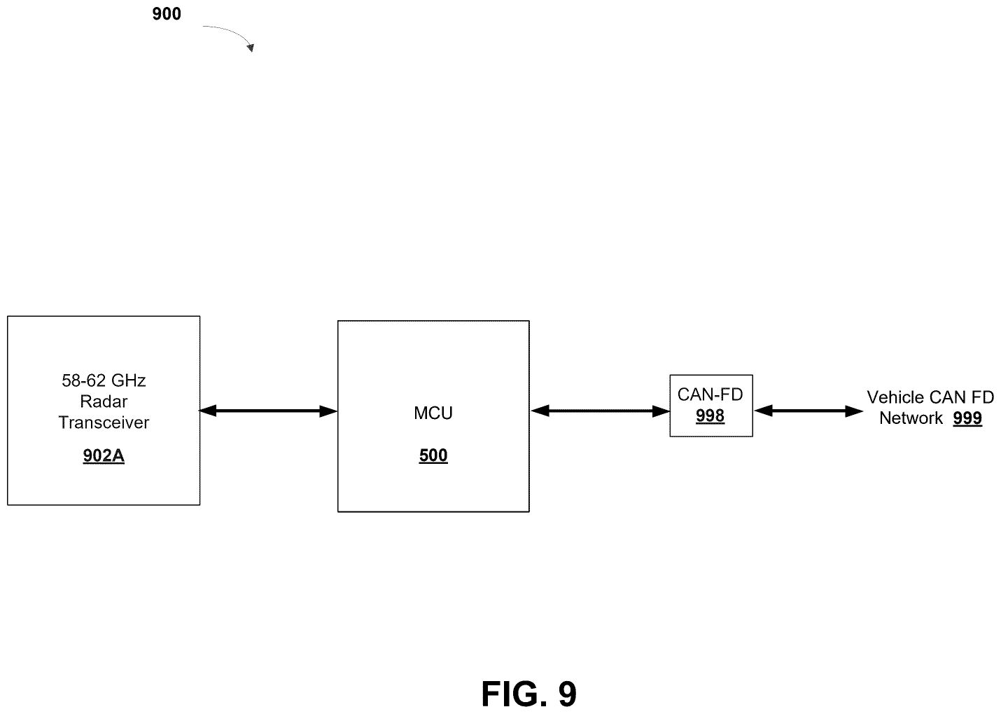

FIG. 9 illustrates a block diagram of a computational system 900 for the 60 GHz radar sensor, according to some embodiments of the present disclosure. Referring to FIG. 9, the computational system 900 for the 60 GHz radar sensor includes 58-62 GHz radar transceiver 902A.

The 58-62 GHz radar transceivers 902A can transmit 60 GHz radar signals and receive the received 60 GHz radar signals from the object. The 58-62 GHz radar transceiver 902A is in communication with an MCU 500. The MCU 500 can process radar signals obtained from the 58-62 GHz radar transceiver 902A. The output of the MCU 500 can be transferred to the vehicle CAN FD network 999 via CAN-FD 998 for radar signal processing.

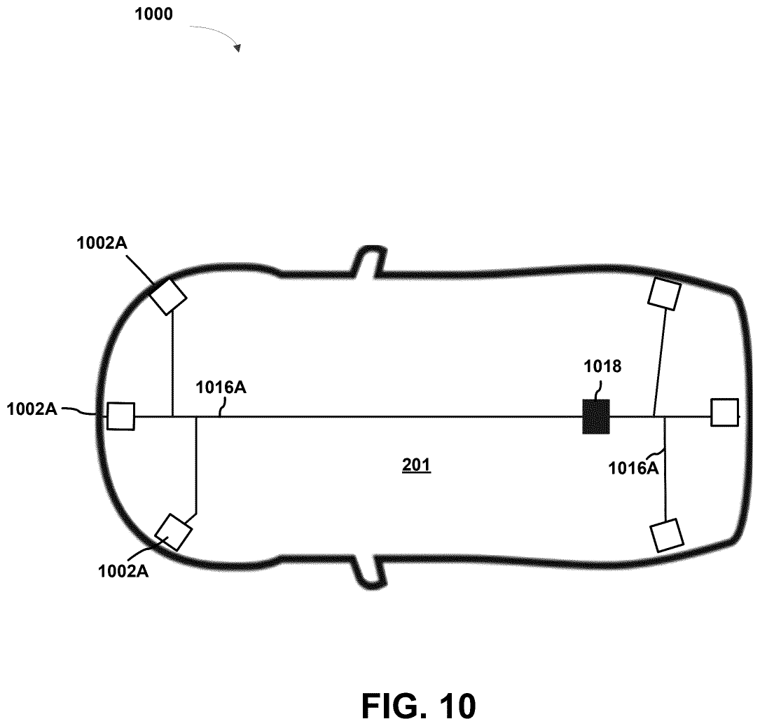

FIG. 10 illustrates an example of a system architecture 1000 for streaming raw radar data via CAN-FD central computation, according to some embodiments of the present disclosure. In some embodiments, raw data from the 60 GHz radar sensor 1002A is streamed via CAN-FD to the parking control module 1018 where the MCU can perform radar signal processing on the two active radar sensors simultaneously.

A front CAN-FD bus 1016A of the vehicle 201 provides a point to point 5 Mbps data transmission from the active radar sensors to the parking control module 1018.

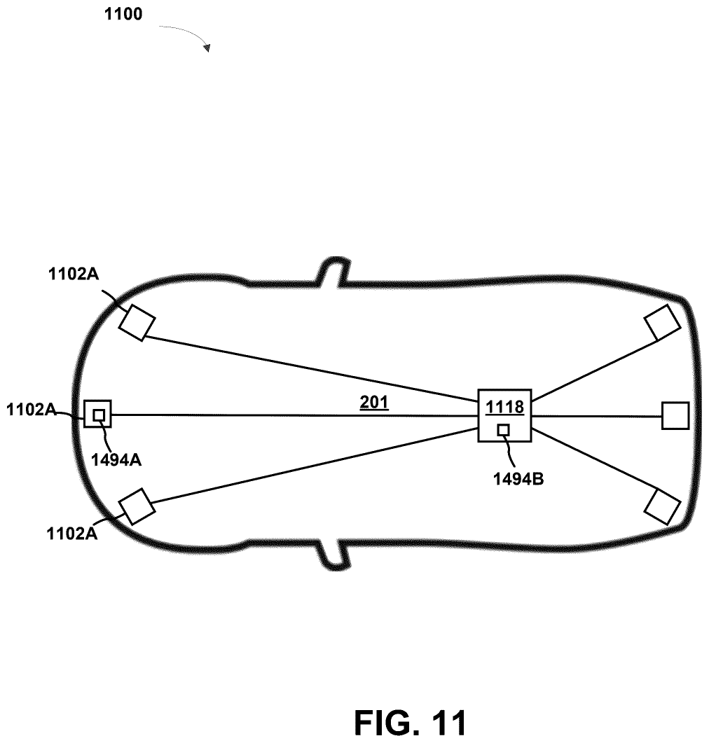

FIG. 11 illustrates an example of a system architecture 1100 for streaming raw radar data via CAN-FD central computation, according to some embodiments of the present disclosure.

In some embodiments, raw data from the 60 GHz radar sensor 1102A may be streamed to the parking control module 1118 of the vehicle 201 using a serializer/de-serializer (SERDES) integrated circuits 1494A, 1494B. The SERDES integrated circuit may convert parallel raw data to serial raw data and vice versa. The SERDES integrated circuit 1494A located at the 60 GHz radar sensors 1102A converts the serial raw data to the parallel raw data. The parallel raw data may be streamed to the parking control module 1118 of the vehicle 201. The SERDES integrated circuit 1494B located at the parking control module 1118 converts the parallel raw data to the serial raw data. The parking control module 1118 includes the MCU that performs signal processing on the two active radar sensors simultaneously.

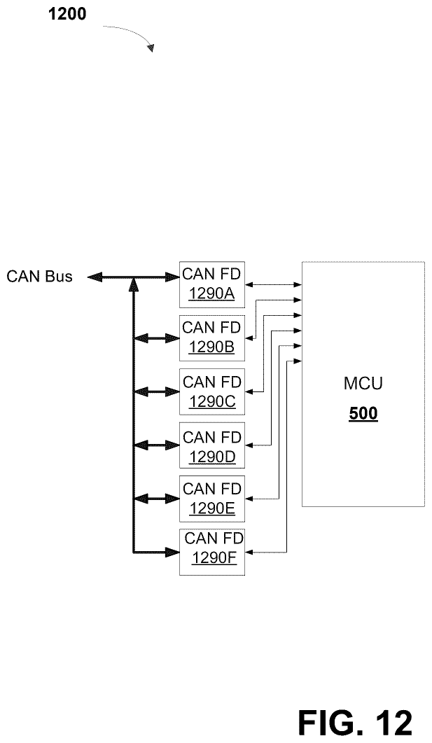

FIG. 12 illustrates a block diagram of a parking control module 1200 receiving raw radar data via CAN-FD, according to some embodiments of the present disclosure.

In some embodiment, raw radar data may be streamed from the 60 GHz radar sensors to parking control module 1200 via CAN-FD nodes. Referring to FIG. 12, six CAN-FD nodes (e.g., 1290A, 1290B, 1290C, 1290D, 1290E, 1290F) receive the raw radar data. The CAN-FD nodes then stream the raw radar data to the MCU 500 that processes two channels of radar data simultaneously.

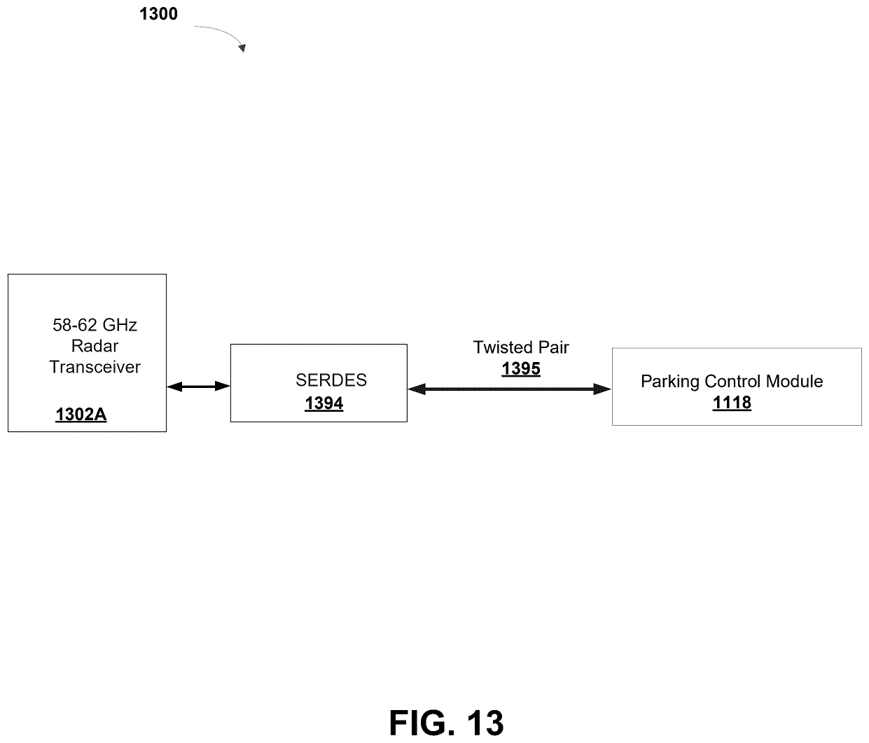

FIG. 13 illustrates a block diagram of a computational system 1300 for streaming raw radar data via an SERDES integrated circuit, according to some embodiments of the present disclosure. Referring to FIG. 13, the SERDES integrated circuit 1394 may be in communication with the 60 GHz radar sensors 1302A. The SERDES integrated circuit 1394 may convert the serial raw data to the parallel raw data. The parallel raw data may be streamed to the parking control module 1118 of the vehicle 201 via a twisted pair 1395.

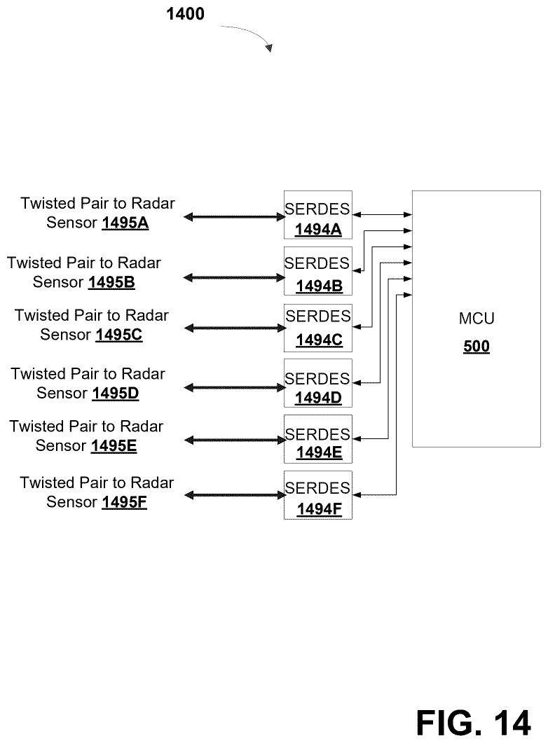

FIG. 14 illustrates an example of a parking control module 1400 receiving raw radar data via SERDES integrated circuit, according to some embodiments of the present disclosure. Referring to FIG. 14, six SERDES integrated circuits (1494A, 1494B, 1494C, 1494D, 1494E, and 1494F) may receive the raw radar data from the 60 GHz radar sensors via twisted pairs (1495A, 1495B, 1495C, 1495D, 1495E, and 1495F). For example, a SERDES integrated circuit 1494A may receive the 60 GHz radar data from the 60 GHz radar sensor via a twisted pair 1495A. Therefore, each 60 GHz radar sensor has a dedicated SERDES integrated circuit. The SERDES integrated circuit 1494A, for example, may convert the parallel raw data to the serial raw data before the MCU 500 receives the raw radar data.

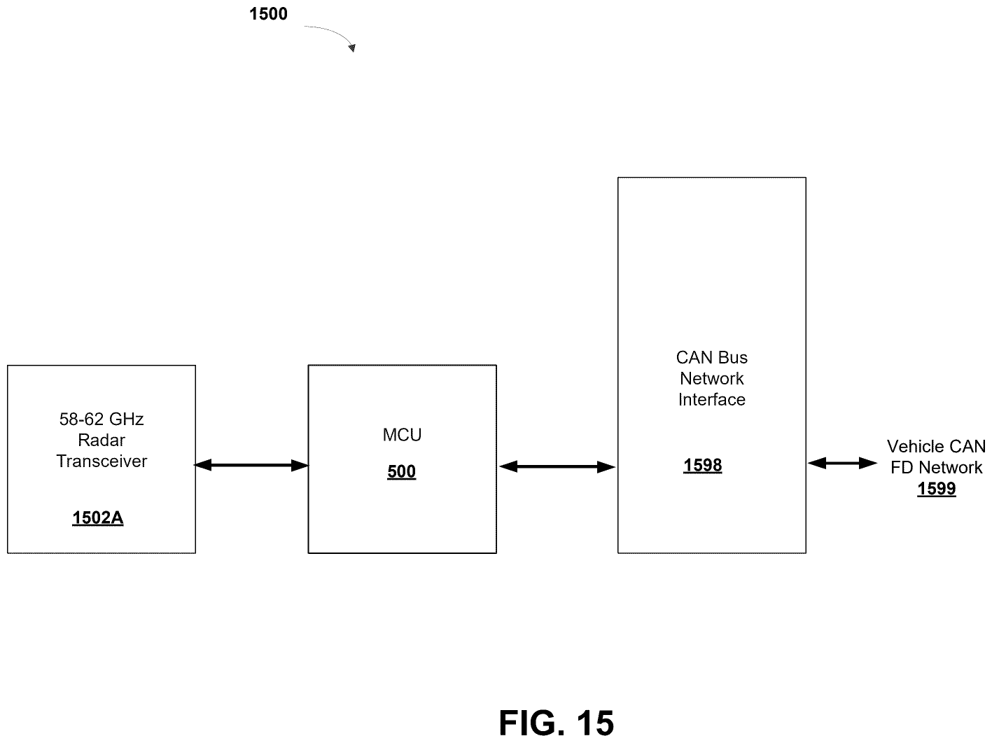

FIG. 15 illustrates a block diagram of a computational system 1500 for the 60 GHz radar sensor operating as an edge compute node sensor, according to some embodiments of the present disclosure. Referring to FIG. 15, the computational system 1500 for the 60 GHz radar sensor includes A 58-62 GHz radar transceiver 1502A. For example, the 58-62 GHz radar transceiver 1502A represents a 60 GHz FMCW radar sensor module. The raw 60 GHz radar data may be streamed to the CAN-FD network 1599 via an interface CAN bus network 1598.

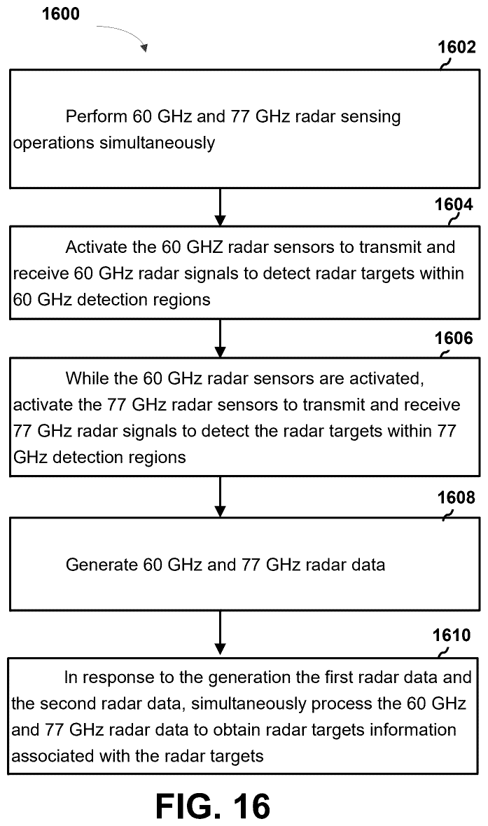

FIG. 16 is a flowchart illustrating an example data processing method 1600 for object sensing according to an embodiment. Method 1600 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. For example, the method 1600 may be performed by the processing device 105 executing radar sensing module 107.

Referring to FIG. 16, the data processing method is associated with 60 GHz radar sensors and 77 GHz radar sensors performing radar sensing.

With reference to FIG. 4 as well, at block 1602, 60 GHz and 77 GHz radar sensing operations may be simultaneously performed. The 60 GHz radar sensing operation may include a sequence of two instances.

At block 1604, 60 GHz radar sensors 202A may be activated to transmit and receive 60 GHz radar signals to detect the radar targets within 60 GHz detection regions (corresponding to beams 420A, 420B, 420C, and 420D) . Referring to FIG. 4, for example, at a first instance of a 60 GHz radar sensing sequence, the 60 GHz radar sensors 202A located at the front left corner (corresponding to beam 420A) of the vehicle 201, at the right side of the front (corresponding to beam 420B) of the vehicle 201, at the rear right corner (corresponding to beam 420C) of the vehicle 201, and at the left side of the rear (corresponding to beam 420D) of the vehicle 201 receive the 60 GHz radar signals to detect the 60 GHz detection regions (corresponding to beams 420A, 420B, 420C, and 420D). At a second instance of the 60 GHz radar sensing sequence, the 60 GHz radar sensors 202A located at the left side of the front (corresponding to beam 422A) of the vehicle 201, at the front right corner (corresponding to beam 422B) of the vehicle 201, at the right side of the rear (corresponding to beam 422C) of the vehicle 201, and at the rear left corner (corresponding to beam 422D) of the vehicle 201 receive the 60 GHz radar signals to detect the 60 GHz detection regions (corresponding to beams 422A, 422B, 422C, and 422D).

At block 1606, while the 60 GHz radar sensors 202A are activated, the 77 GHz radar sensors 202B located at the four corners of the vehicle may be activated to transmit and receive 77 GHz radar signals to detect the radar targets within 77 GHz detection regions (corresponding to beams 430A, 430B, 430C, and 430D). In some other embodiments, for example, the 77 GHz radar sensing operation may include a sequence of two instances. For example, at a first instance of the 77 GHz radar sensing sequence, the 77 GHz radar sensors 202B located at the front corners of the vehicle may be activated to transmit and receive 77 GHz radar signals to detect the radar targets within a 77 GHz detection regions corresponding to beams 430A and 430B. At a second instance of the 77 GHz radar sensing sequence, the 77 GHz radar sensors 202B located at the rear corners of the vehicle may be activated to transmit and receive 77 GHz radar signals to detect the radar targets within 77 GHz detection regions corresponding to beams 430C and 430D. In some other embodiments, at a first instance of the 77 GHz radar sensing sequence, the 77 GHz radar sensors 202B located at the front left corner and the rear right corner of the vehicle 201 may be activated to transmit and receive 77 GHz radar signals to detect the radar targets within 77 GHz detection regions corresponding to beams 430A and 430C. At a second instance of the 77 GHz radar sensing sequence, the 77 GHz radar sensors 202B located at the front right corner and the rear left corner of the vehicle may be activated to transmit and receive 77 GHz radar signals to detect the radar targets within 77 GHz detection regions corresponding to beams 430B and 430D.

At block 1608, 60 GHz and 77 GHz radar data may be generated simultaneously.

At block 1610, in response to the generating the 60 GHz and the 77 GHZ radar data, the 60 GHz radar data and the 77 GHz radar data may be simultaneously processed by an MCU 500 to obtain radar target information associated with the radar targets. For example, referring to FIGS. 6, 60 GHz radar data of the radar sensor 202A-1 may be processed by SPU 542.

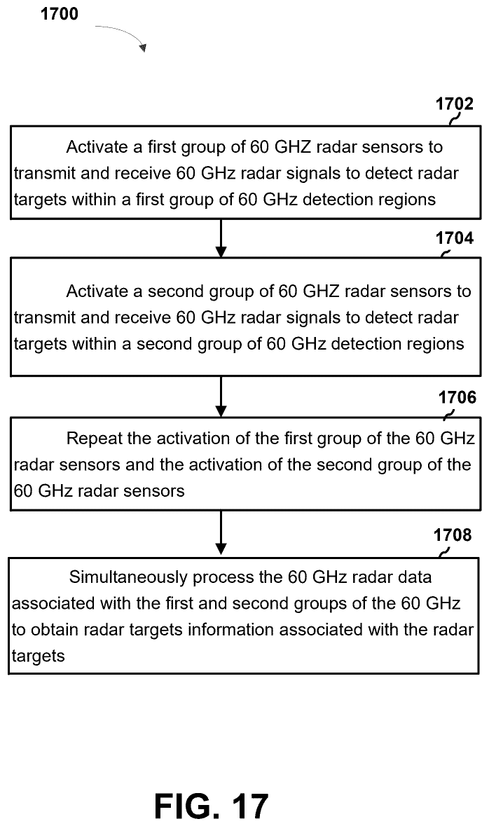

FIG. 17 is a flowchart illustrating an example data processing method 1700 for object sensing according to an embodiment. Method 1700 may be performed by processing logic that may comprise hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. For example, the method 1700 may be performed by the processing device 105 executing radar sensing module 107.

Referring to FIG. 17, the data processing method is associated with 60 GHz radar sensors performing radar sensing.

With reference to FIG. 3 as well, at block 1702, a first group of 60 GHz radar sensors may be activated to transmit and receive 60 GHz radar signals to detect radar targets within a first group of 60 GHz detection regions. For example, a group of odd-numbered 60 GHz radar sensors 202A transmit 60 GHz radar signals to detect radar targets within 60 GHz detection regions corresponding to beams 320A, 320B, 320C, and 320D. Beam 320A may cover a region surrounding a front left corner of the vehicle 201 while beam 320B may cover a region surrounding left side of a front of the vehicle 201. Beam 320C may cover a region surrounding a rear right corner of the vehicle 201 while beam 320D may cover a region surrounding left side of a rear of the vehicle 201.

At block 1704, a second group of 60 GHz radar sensors may be activated to transmit and receive 60 GHz radar signals to detect radar targets within a second group of 60 GHz detection regions. For example, a group of even-numbered 60 GHz radar sensors 202A transmit 60 GHz radar signals to detect radar targets within 60 GHz detection regions corresponding to beams 322A, 322B, 322C, and 322D. Beam 322B may cover a region surrounding a front right corner of the vehicle 201 while beam 322A may cover a region surrounding left side of a front of the vehicle 201. Beam 322D may cover a region surrounding a rear left corner of the vehicle 201 while beam 322C may cover a region surrounding right side of a rear of the vehicle 201.

At block 1706, the activation of the first group of the 60 GHz radar sensors and the second group of the 60 GHz radar sensors may be repeated.

With reference to FIG. 5 as well, at block 1708, the 60 GHz radar data associated with the first and the second group of the 60 GHz radar sensors are simultaneously processed by an MCU 500. For example, SPU 542 processes the 60 GHz radar data associated with the first group of the 60 GHz radar sensors while SPU 544 processes the 60 GHz radar data associated with the second group of the 60 GHz radar sensors.

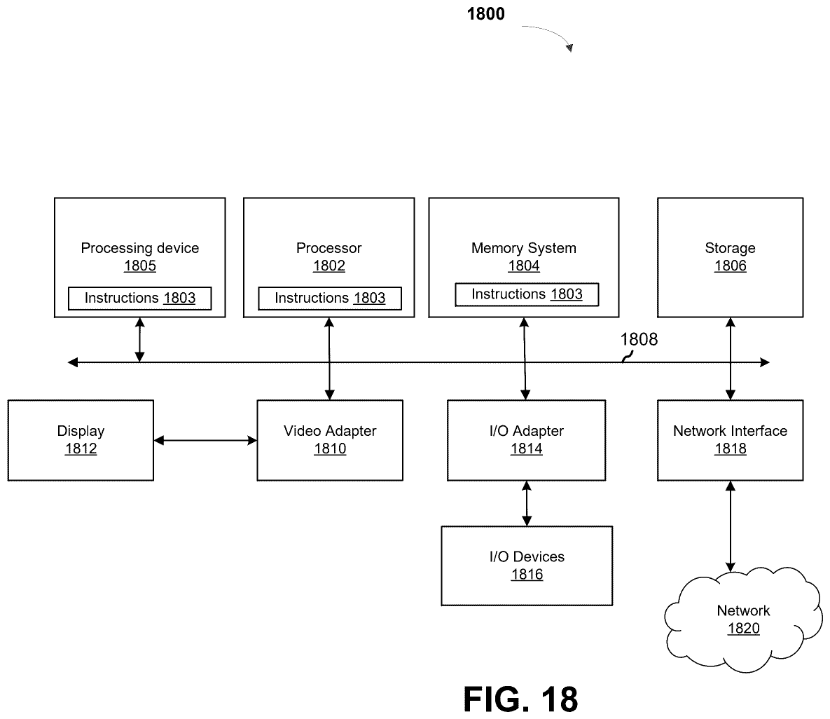

FIG. 18 illustrates a block diagram of a device 1800, according to some embodiments of the present disclosure. The device 1800 depicts a general-purpose platform and the general components and functionality that may be used to implement portions of the embodiment radar based systems discussed herein. The device 1800 may include, for example, a processor 1802, memory system 1804, and a mass storage device 1806 connected to a bus system 1808 configured to perform the processes discussed above.

In embodiments, the processors(s) 1802 may include processing device(s) 1805 such as a Programmable System on a Chip (PSoC) processing device, developed by Cypress Semiconductor Corporation, San Jose, Calif. Alternatively, the device 1800 may include one or more other processing devices known by those of ordinary skill in the art, such as a microprocessor or central processing unit, an application processor, a host controller, a controller, special-purpose processor, digital signal processor (DSP), an application specific integrated circuit (ASIC), a field programmable gate array (FPGA), or the like. Bus system 1808 may include a communication block (not shown) to communicate with an internal or external component, such as an embedded controller or an application processor, via network interfaces(s) 1818 and/or bus system 1808.

Components of the device 1800 may reside on a common carrier substrate such as an IC die substrate, a multi-chip module substrate, or the like. Alternatively, components of the device 1800 may be one or more separate ICs and/or discrete components.

The memory system 1804 may include volatile memory and/or non-volatile memory which may communicate with one another via the bus system 1808. The memory system 1804 may include, for example, random access memory (RAM) and program flash. RAM may be static RAM (SRAM), and program flash may be a non-volatile storage, which may be used to store firmware (e.g., control algorithms executable by processor(s) 1802 to implement operations described herein). The memory system 1804 may include instructions 1803 that when executed perform the methods described herein. Portions of the memory system 1804 may be dynamically allocated to provide caching, buffering, and/or other memory-based functionalities.

The memory system 1804 may include a drive unit providing a machine-readable medium on which may be stored one or more sets of instructions 1803 (e.g., software) embodying any one or more of the methodologies or functions described herein. The instructions 1803 may also reside, completely or at least partially, within the other memory devices of the memory system 1804 and/or within the processor(s) 1802 during execution thereof by the device 1800, which in some embodiments, constitutes machine-readable media. The instructions 1803 may further be transmitted or received over a network via the network interfaces(s) 1818. The communication interface(s) 1818 may be where the device 1800 discussed herein is implemented.

The device 1800 may further include a video adapter 1810 to provide connectivity to a local display 1812 (e.g., a liquid crystal display (LCD), touchscreen, a cathode ray tube (CRT), and software and hardware support for display technologies), and an input-output (I/O) Adapter 1814 to provide an input/output interface for one or more input/output devices 1816, such as a mouse, a keyboard, printer, tape drive, CD drive, buttons, switches, touchpad, touchscreens, and software and hardware support for user interfaces keyboard.

The device 1800 also includes a network interface 1818, which may be implemented using a network adaptor configured to be coupled to a wired link, such as an Ethernet cable, USB interface, or the like, and/or a wireless/cellular link for communications with a network 1820. The network interface 1818 may also include a suitable receiver and transmitter for wireless communications. It should be noted that the device 1800 may include other components. For example, the device 1800 may include power supplies, cables, a motherboard, removable storage media, cases, and the like. These other components, although not shown, are considered part of the device 1800.

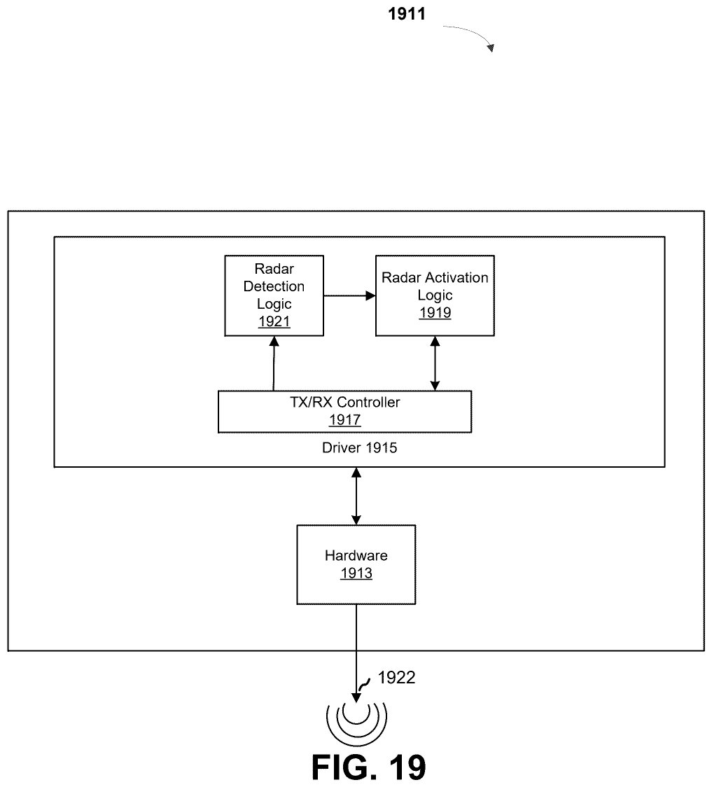

FIG. 19 is a block diagram of a device 1911 deployed in an automobile configured to receive radar signals, in accordance with some embodiments of the present disclosure. Further, while only a single device 1911 is illustrated, the term “device” shall also be taken to include any collection of machines that individually or jointly execute a set (or multiple sets) of instructions to perform any one or more of the methodologies discussed herein.

The device 1911 may be the 60 GHz radar sensor 202A or the 77 GHz radar sensor 202B on the vehicles 101, 201, and may practice the operations of method 1600. The device 1911 may include one or more antennas 1922, hardware 1913 and driver 1915. The driver 1915 may include Tx/Rx controller 1917, radar activation logic 1919, and radar signal detection logic 1921. The hardware 1913 may be configured to transmit or receive radar signals on an operating channel through the antennas 1922. The antennas 1922 may also be used to receive radar signals on dedicated channels. In one embodiment, the radar activation logic 1919 may be configured to control the activation of the radar sensor according to a TDM technique. The radar activation logic 1919 may be configured to which radar sensor to be activated at a predefined time slot. The radar activation logic 1919 may be configured to control the sequence of the activation of the radar sensor.

The Tx/Rx controller 1917 may be configured to demodulate and decode received radar signals and to encode and modulate radar signals for transmission. The radar signal detection logic 1921 and the radar activation logic 1919 may be configured to detect radar signals. In one embodiment, the radar activation logic 1919 may implement drivers to read stored signals in hardware, and to simultaneously process the 60 GHz radar data and the 77 GHz radar data disclosed herein.

In one embodiment, the device 1911 may include a memory and a processing device. The memory may be synchronous dynamic random access memory (DRAM), read-only memory (ROM)), or other types of memory, which may be configured to store the code to perform the function of the driver 1915. The processing device may be provided by one or more general-purpose processing devices such as a microprocessor, central processing unit, or the like. In an illustrative example, processing device may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device may also comprise one or more special-purpose processing devices such as an application specific integrated circuit (ASIC), a field programmable gate array (FPGA), a digital signal processor (DSP), network processor, or the like. The processing device may be configured to execute the operations described herein, in accordance with one or more aspects of the present disclosure, for performing the operations and steps discussed herein.

While a machine-readable medium is in some embodiments a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing or encoding a set of instructions for execution by the machine and that cause the machine to perform any one or more of the example operations described herein. The term “machine-readable medium” shall accordingly be taken to include, but not be limited to, solid-state memories, and optical and magnetic media.

In the above description, numerous details are set forth. It will be apparent, however, to one of ordinary skill in the art having the benefit of this disclosure, that embodiments of the present disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “transmitting,” “receiving,” “comparing,” “determining,” “detecting,” “classifying,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance, or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such.

Embodiments descried herein may also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, flash memory, or any type of media suitable for storing electronic instructions. The term “computer-readable storage medium” should be taken to include a single medium or multiple media (e.g., a centralized or distributed database and/or associated caches and servers) that store one or more sets of instructions. The term “computer-readable medium” shall also be taken to include any medium that is capable of storing, encoding, or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present embodiments.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the embodiments as described herein.

The above description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present embodiments. Thus, the specific details set forth above are merely exemplary. Particular implementations may vary from these exemplary details and still be contemplated to be within the scope of the present embodiments.

It is to be understood that the above description is intended to be illustrative and not restrictive. Many other embodiments will be apparent to those of skill in the art upon reading and understanding the above description. The scope of the embodiments should, therefore, be determined with reference to the appended claims, along with the full scope of equivalents to which such claims are entitled.

What is claimed is:

1. A method for scheduling of activation of dual frequency radar transceivers for detecting at least one radar target, comprising:
until each of a plurality of first radar transceivers and a second radar transceiver has been activated, iteratively:
obtaining, using the plurality of first radar transceivers, a first received radar signal;
generating first radar data based on the first received radar signal to detect the at least one radar target within a first detection region and a second detection region;
obtaining, using the second radar transceiver, a second received radar signal, wherein the second radar transceiver is different from the plurality of the first radar transceivers; and
generating second radar data based on the second received radar signal to detect the at least one radar target within a third detection region.

2. The method of claim 1, further comprising:
in response to the generating the first radar data and the second radar data, simultaneously processing the first radar data and the second radar data to obtain radar target information associated with the at least one radar target.

3. The method of claim 1, wherein the obtaining using the plurality of the first radar transceivers comprises:
transmitting, via a transmitter of the plurality of the first radar transceivers, a first radar signal; and
receiving, via a receiver of the plurality of the first radar transceivers, the first received radar signal.

4. The method of claim 3, wherein the first radar transceiver is a 60 Gigahertz (GHz) radar transceiver.

5. The method of claim 1, wherein the obtaining using the second radar transceiver comprises:
transmitting, via a second radar transmitter, the second radar signal of a second frequency band; and
receiving, via a second radar receiver, the second received radar signal.

6. The method of claim 1, wherein the second radar transceiver is a 77 GHz radar transceiver.

7. The method of claim 1, wherein the second radar transceiver is a 60 GHz radar transceiver.

8. The method of claim 1, wherein the plurality of the first radar transceivers comprise: a 60 GHz radar transceiver and a 77 GHz radar transceiver.

9. The method of claim 2, wherein the simultaneously processing the first radar data and the second radar data comprises:
processing, using a first signal processing unit, the first radar data; and
processing, using a second signal processing unit, the second radar data.

10. The method of claim 1, wherein an overlapping of a beam pattern from two of the plurality of the first radar transceivers is below a predefined threshold to minimize interference.

11. The method of claim 1, wherein the plurality of the first radar transceivers are positioned at opposing corners of a vehicle.

12. The method of claim 1, wherein the plurality of the first radar transceivers and the second radar transceiver are sequentially activated according to a round robin order.

13. An apparatus comprising:
a device configured to obtain a first received radar signal and a second received radar signal; and
a processing device operatively coupled to the device, the processing device configured to:
until each of a plurality of first radar transceivers and a second radar transceiver has been activated, iteratively:
obtain, using the plurality of first radar transceivers, a first received radar signal;
generate first radar data based on the first received radar signal to detect at least one radar target within a first detection region and a second detection region; and
obtain, using the second radar transceiver, a second received radar signal, wherein the second radar transceiver is different from the plurality of the first radar transceivers;
generate second radar data based on the second received radar signal to detect the at least one radar target within a third detection region.

14. The apparatus of claim 13, wherein the processing device is further configured to:
in response to the generate the first radar data and the second radar data, simultaneously process the first radar data and the second radar data to obtain radar targets information associated with the radar targets.

15. The apparatus of claim 13, wherein to obtain using the plurality of the first radar transceivers, the processing device is configured to:
transmit, via a transmitter of the plurality of the first radar transceivers, a first radar signal; and
receive, via a receiver of the plurality of the first radar transceivers, the first received radar signal.

16. The apparatus of claim 15, wherein the first radar transceiver is a 60 GHz radar transceiver.

17. The apparatus of claim 13, wherein to obtain using the second radar transceiver, the processing device is configured to:
transmit, via a second radar transmitter, the second radar signal of a second frequency band; and
receive, via a second radar receiver, the second received radar signal.

18. The apparatus of claim 13, wherein the second radar transceiver is a 77 GHz radar transceiver.

19. The apparatus of claim 13, wherein the plurality of the first radar transceivers comprise: a 60 GHz radar transceiver and a 77 GHz radar transceiver.

20. A non-transitory computer-readable medium storing instructions that, when executed by one or more processors of a device, cause the device to:
until each of a plurality of first radar transceivers and a second radar transceiver has been activated, iteratively:
obtain, using the plurality of first radar transceivers, a first received radar signal;
generate first radar data based on the first received radar signal to detect at least one radar target within a first detection region and a second detection region;
obtain, using the second radar transceiver, a second received radar signal, wherein the second radar transceiver is different from the plurality of the first radar transceivers; and
generate second radar data based on the second received radar signal to detect the at least one radar target within a third detection region.
